(19) United States
(12) Patent Application Publication
(10) Pub. No.: US 2011/0006488 A1
(43) Pub. Date: Jan. 13, 2011

(54) FLAT GASKET

(75) Inventors: Roland Belser, Haigerloch (DE); Josef Beck, Villingen-Schwennigen (DE); Harald Niebergall, Horb (DE)

Correspondence Address: SCULLY SCOTT MURPHY & PRESSER, PC, 400 GARDEN CITY PLAZA, SUITE 300, GARDEN CITY, NY, 11530, US

(73) Assignee: ROBERT BOSCH GMBH, Stuttgart (DE)

(21) Appl. No.: 12/447,485

(22) PCT Filed: Dec. 19, 2007
(86) PCT No.: PCT/EP2007/011223

§ 371 Date: Apr. 28, 2009

(30) Foreign Application Priority Data
Dec. 19, 2006 (DE) 10 2006 060 017.7

(51) Int. Cl. F16J 15/10

(52) U.S. Cl. 277/616; 277/602; 277/627

(57) ABSTRACT

A flat gasket (1) for a valve comprises a substantially plate-like base body (2), which corresponds substantially to the contour (9) of a valve housing (11) to be connected thereto and which is provided with at least one first through-bore (3) for leading through a connecting element of the valve (11), with at least one second (6) and with at least one third through-bore (5) for leading through fastening means. The second through-bore (6) has a diameter which is different from the diameter of the third through-bore (5).

The invention relates to a flat gasket.

There are various types of such flat gaskets. One type is known, for example, from DE 10 2005 025 942 A1.

In the prior art, it is known to seal regulator valves using an O-ring as the sealing means. However, it frequently happens that the O-rings are forgotten during the mounting of the valves and after a few hours of operation leakages occur.

When using flat gaskets as the sealing means for regulator valves instead of O-rings, there is, in contrast, the risk of an incorrect mounting with regard to the position or arrangement of the flat gasket on the valve occurring frequently, owing to the specific configuration of a flat gasket with regard to the connection and the fastening points of the valve thereon.

Furthermore, when using flat gaskets known from the prior art, there is the risk that after the fitting of the valve it is no longer possible to ascertain whether the gasket has been inserted or not. If the flat gasket is missing from the fitted valve, leakages then likewise occur and thus complaints result.

It is therefore the object of the invention to provide a flat gasket in which the ease of mounting and the reliability of the gasket is improved.

The object is achieved by the features of Claim 1. The subclaims contain advantageous developments.

The flat gasket according to the invention has the advantage that by providing at least one second and at least one third through-bore which are formed with a different diameter from one another in the flat gasket and which serve for leading through fastening means, an incorrect mounting is prevented.

It is particularly preferred if in each case a pair of second through-bores with the same diameter and a pair of third through-bores with the same diameter is provided, the diameter of the pair of second through-bores being different to the diameter of the pair of third through-bores. The pairs of through-bores with a different diameter are in this case arranged in such a manner in the flat gasket as to allow a use of the flat gasket in only one defined position. In particular, the pairs are arranged in such a manner on the flat gasket that each through-bore has as its nearest neighbour in each case a through-bore with the same diameter and a through-bore with a different diameter.

In order to make the flat gasket, in the mounted state of the same, recognisable from outside on the end product, the outer contour of the flat gasket is designed, in at least one portion, larger than the outer contour, for example, of a valve housing on which the flat gasket can be mounted, so as to form a projection of the flat gasket beyond the valve housing in the mounted state. The projection thus constitutes a simple and reliable checking medium in order to check in the mounted state whether a gasket has been inserted.

In order to achieve a particularly secure and reliable seal, preferably the first through-bores provided on the base body of plate-like design, which serve for leading through pressure lines for example and thus enable a connection of the valve, are surrounded by an encircling collar or a bead running in a closed manner around the through-bore. The base body is coated on both sides with an elastic material, preferably rubber for example.

In order to provide a secure fixing of the flat gasket, so that the flat gasket is not lost when in a state premounted on a valve, and also to enable the flat gasket furthermore to be mountable in any fitting position, preferably a holding device is provided on the second through-bores which comprises a pair of protruding holding clips which protrude from the opening of the second through-bore. As a result of the fact that the holding clips are provided only on the second through-bores, which have a greater diameter than the third through-bores, an incorrect mounting of the flat gasket on the valve is likewise prevented, since the flat gasket can be mounted only in a defined position which is predetermined by the different through-bores and the holding clips.

An exemplary embodiment of a flat gasket according to the invention is illustrated in a simplified manner in the drawing and is explained in more detail in the following description. In the drawing:

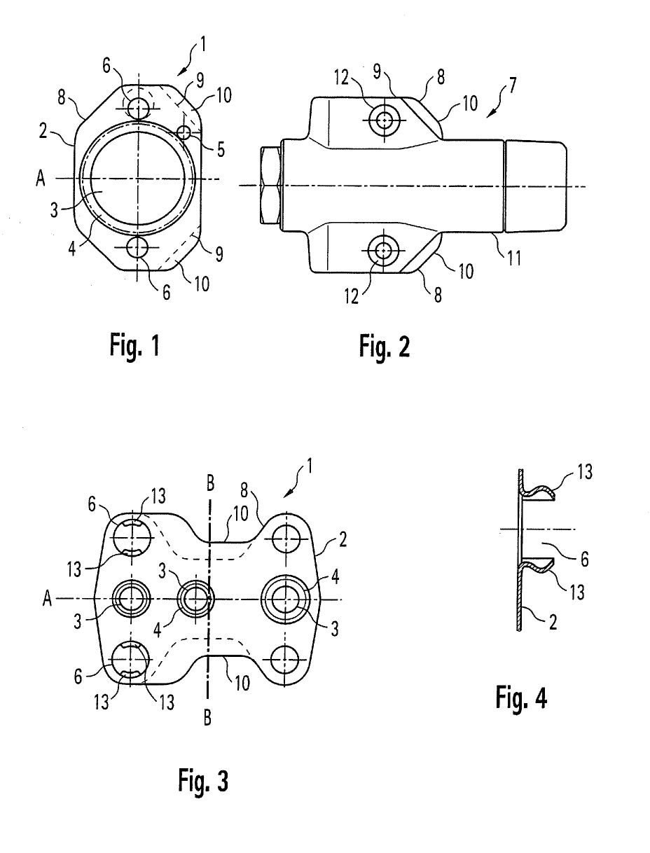

FIG. 1 shows a plan view of a flat gasket according to the invention;

FIG. 2 shows a side view of an output regulator valve with the flat gasket according to the invention;

FIG. 3 shows a plan view of a further embodiment of the flat gasket according to the invention; and

FIG. 4 shows a sectional view through a portion of the flat gasket according to the invention.

FIG. 1 shows a plan view of the flat gasket 1 according to the invention which is suitable for sealing an output regulator valve (not illustrated). The flat gasket 1 is constructed from a substantially plate-shaped base body 2 which may be produced, for example, from a rubber-coated base material. In the plate-shaped base body 2 there is provided, in this exemplary embodiment, a first through-bores 3, which in the mounted state of the flat gasket 1 serves for enabling a connection of the valve by means of a connection or a line. For the sealing of the first through-bore 3 there is provided an encircling collar 4 or the ring-shaped bead on the plate-shaped base body 2. The first collar 4 has a closed course and is preferably produced by shaping the base body 2.

The plate-shaped base body 2 further has a pair of second through-bores 6, which serve for fastening the flat gasket 1 by means of suitable fastening means, for example by means of screws, to the valve (not illustrated). The second through-bores 6 have the same diameter and are arranged on the flat gasket 1 mirror-symmetrically with respect to an axis A which divides the flat gasket 1 into two halves.

A third through-bore 5 is further provided in the plate-shaped base body 2 of the flat gasket 1, this through-bore having a smaller diameter than that of the second through-bore 6. The third through-bore 5 is intended for receiving a pin which is provided on the valve or valve housing, and which serves as a means for preventing rotation. Also, by providing the third through-bore, a uniquely defined positioning of the flat gasket on the valve is determined, so that an incorrect mounting is precluded.

The plate-shaped base body 2 of the flat gasket 1 has an outer contour 8 which corresponds substantially to the outer contour 9 of the valve housing, which is indicated by the dashed line in FIG. 1. However, in two portions the outer contour 8 of the flat gasket 1 is provided with a projection 10 relative to the contour 9 of the valve housing. This enables a part of the flat gasket 1 to be visible in a mounted state of the valve housing, so that the flat gasket 1 is not forgotten during the mounting and it is possible to check whether the flat gasket 1 has been mounted.

In FIG. 2 a side view of an output regulator valve 7 is illustrated, with the flat gasket 1 according to the invention already premounted thereon. The valve housing 11 has an outer contour 9 which coincides substantially with the outer contour 8 of the plate-shaped base body 2 of the flat gasket 1, but differs therefrom in two portions. Since the flat gasket 1 according to the invention is designed with a projection 10 relative to the valve housing 11, the flat gasket 1 remains visible also in the fitted state of the valve 7.

The housing 11 of the output regulator valve 7 is further provided with a pair of mutually opposite through-bores 12, which coincide in their position with the two through-bores 6 of the flat gasket 1 when the flat gasket 1 has been mounted on the valve housing 11. The second through-bores 6 serve for leading through fastening means in order to fix the valve 7 to the flat gasket 1 and a further component (not illustrated).

FIG. 3 shows a plan view of a further exemplary embodiment of the flat gasket 1 according to the invention. The flat gasket 1 shown here is designed to seal a pressure valve (not shown). The plate-shaped base body 2 of the flat gasket 1 in this exemplary embodiment is provided with three first through-bores 3 for leading through pressure lines of the valve, which are arranged asymmetrically with respect to an axis B dividing the plate-shaped base body 2 into two equal halves. Two of the three first through-bores 3 have the same diameter, but the third of the first through-bores 3 has a greater diameter. The asymmetrical arrangement of the first through-bores 3 on the plate-shaped base body 2 and their different diameters prevent an incorrect mounting. For better sealing, each of the three first through-bores 3 is surrounded by a ring-shaped collar. A further sealing measure, not illustrated here, would be the provision of yet a further collar (not illustrated), which surrounds all of the three first through-bores 3 as a whole, with the result that a double seal can be obtained.

A pair of second through-bores 6 is arranged, with respect to the axis B, on the left half of the plate-shaped base body 2 in FIG. 3. The two second through-bores 6 lie opposite each other mirror-symmetrically with respect to the axis A on the plate-shaped base body 2. The openings of the second through-bores 6 are each provided with a holding device in the form of two holding clips 13 which are arranged opposite in the opening and protrude substantially at right angles from the plate-shaped base body 2.

In the half, on the right in FIG. 3, of the flat gasket 1 divided by the axis B, there are provided a pair of third through-bores 5, which have a smaller diameter than the second through-bores 6 and also no holding devices, in contrast to the second through-bores 6. The two third through-bores 5 are arranged mirror-symmetrically with respect to the axis A. Overall, the arrangement of the through-bores with different diameters on the plate-shaped base body 2 results in an asymmetrical arrangement, which prevents an incorrect mounting. Moreover, an incorrect mounting is further avoided as a result of the fact that the holding clips 13 are provided exclusively in the through-bores of greater diameter.

Finally, FIG. 3 shows that the outer contour 8 of the plate-shaped base body 2 of the flat gasket 1 corresponds substantially to the outer contour 9 of the valve (indicated by the dashed line in FIG. 3), but at two portions is designed with in each case a projection 10 relative to the contour 9 of the valve housing. This makes it possible in the fitted state to check whether the flat gasket 1 is fitted.

FIG. 4 shows a sectional view through a portion of the plate-shaped base body 2 in a region of a second through-bore 6. The second through-bore 6 is provided, at its opening, with a pair of mutually opposite holding clips 13 which protrude substantially perpendicularly from the plate-shaped base body 2. The holding clips 13 are formed in one piece and produced from an elastic material. The holding clips are preferably integrally formed on the base body 2 and thus likewise coated with an elastomer, just as the base body. In the premounted state of the flat gasket 1 on a valve (not shown), they fix the flat gasket to the valve, for example by an engagement with cylindrical pins which are provided on the valve housing and are led through the two through-bores 6.

If the holding clips 13, which on the one hand serve for fixing and on the other hand can also prevent an incorrect mounting, are provided, other more costly fixing measures known from the prior art may be dispensed with.

The flat gasket 1 according to the invention thus provides an effective seal, for example, of a variable displacement pump relative to a regulator or a valve. All the described and/or drawn features can be combined with one another as desired, within the scope of the invention.

1. Flat gasket for a valve,
the flat gasket comprising a substantially plate-like base body, which corresponds substantially to the contour of a valve housing to be connected thereto and which is provided with at least one first through-bore for leading through a connecting element of the valve, with at least one second and with at least one third through-bore for leading through fastening means,
and
the second through-bore having a diameter which is different from the diameter of the third through-bore.

2. Flat gasket according to claim 1,
wherein in each case a pair of second through-bores with the same diameter and a pair of third through-bores with the same diameter is provided, the diameter of the pair of second through-bores being different to the diameter of the pair of third through-bores.

3. Flat gasket according to claim 2,
wherein the outer contour of the flat gasket is designed, in at least one portion, larger than the outer contour of the valve housing on which the flat gasket can be mounted, so as to form a projection of the flat gasket beyond the valve housing in the mounted state.

4. Flat gasket according to claim 1,
wherein the plate-like base body consists of a rubber-coated base material.

5. Flat gasket according to claim 1,
wherein a holding device is provided in the at least one second through-bore.

6. Flat gasket according to claim 5,
wherein the holding device comprises a pair of protruding holding clips which protrude from the opening of the through-bore.

7. Flat gasket according to claim 6,
wherein the holding clips are integrally formed on the base body.

8. Flat gasket according to claim 6,
wherein each holding clip of the pair of holding clips is of one-piece design.

9. Flat gasket according to claim 5,
wherein the second through-bores have a greater diameter than the third through-bores, the holding device being provided only in the second through-bores.

10. Flat gasket according to claim 1,
wherein the at least one first through-bore is surrounded by an encircling collar to improve the sealing.

11. Flat gasket according to claim 10,
wherein the encircling collar is formed by shaping the plate-shaped base body.

12. Flat gasket according to claim 1,
wherein the flat gasket is designed to seal an output regulator valve.

13. Flat gasket according to claim 1,
wherein the flat gasket is designed to seal a proportional pressure-reducing valve.
